(19) United States
(12) Patent Application Publication
(10) Pub. No.: US 2006/0023885 A1
(43) Pub. Date: Feb. 2, 2006

(54) Two-way QKD system with backscattering suppression

(76) Inventors: Alexei Trifonov, Boston, MA (US); Anton Zavriyev, Swampscott, MA (US)

Correspondence Address: MAGIQ TECHNOLOGIES, INC, 171 MADISON AVENUE, SUITE 1300, NEW YORK, NY, 10016-5110, US

(21) Appl. No.: 10/900,491

(22) Filed: Jul. 28, 2004

(51) Int. Cl. H04K 1/00

(52) U.S. Cl. 380/256

(57) ABSTRACT

Systems and methods for suppressing the unwanted detection of backscattered light in a two-way quantum key distribution (QKD) system is disclosed. The system includes a first QKD station that has two or more laser sources that emit light at different wavelengths, and corresponding two or more sets of detectors. In a two-way QKD system, backscattered light is typically generated in an optical fiber link connecting the first and second QKD stations by the relatively strong outgoing optical pulses. To prevent the backscattered light from interfering with the detection of the weak optical pulses returned from the second QKD station to the first station, a controller sequentially activates different light sources, and also sequentially activates the different sets of detectors.

### FIELD OF THE INVENTION

The present invention relates to quantum cryptography, and in particular relates to quantum key distribution (QKD) systems, and more particularly to two-way QKD systems.

### BACKGROUND OF THE INVENTION

Quantum key distribution involves establishing a key between a sender (“Alice”) and a receiver (“Bob”) by using weak (e.g., 0.1 photon on average) optical signals transmitted over a “quantum channel.” The security of the key distribution is based on the quantum mechanical principle that any measurement of a quantum system in unknown state will modify its state. As a consequence, an eavesdropper (“Eve”) that attempts to intercept or otherwise measure the quantum signal will introduce errors into the transmitted signals, thereby revealing her presence.

The general principles of quantum cryptography were first set forth by Bennett and Brassard in their article “Quantum Cryptography: Public key distribution and coin tossing,” Proceedings of the International Conference on Computers, Systems and Signal Processing, Bangalore, India, 1984, pp. 175-179 (IEEE, New York, 1984). Specific QKD systems are described in U.S. Pat. No. 5,307,410 to Bennett, and in the article by C. H. Bennett entitled “Quantum Cryptography Using Any Two Non-Orthogonal States”, Phys. Rev. Lett. 68 3121 (1992).

The general process for performing QKD is described in the book by Bouwmeester et al., “The Physics of Quantum Information,” Springer-Verlag 2001, in Section 2.3, pages 27-33. During the QKD process, Alice uses a random number generator (RNG) to generate a random bit for the basis (“basis bit”) and a random bit for the key (“key bit”) to create a qubit (e.g., using polarization or phase encoding) and sends this qubit to Bob.

The article by Ribordy et al., entitled “Automated ‘Plug and play” quantum key distribution,” Electronics Letters Vol. 34, No. 22 Oct. 29, 1998 (“the Ribordy paper”) and the U.S. Pat. No. 6,188,768 each describe a so-called “two way” system wherein quantum signals are sent from a first QKD station to a second QKD station and then back to the first QKD station. Typically, the quantum signals sent from the first QKD station to the second QKD station are relatively strong (e.g., hundreds or thousands of photons per pulse on average), and are attenuated down to quantum levels (i.e., one photon per pulse or fewer) at the second QKD station prior to being returned to the first QKD station.

The performance of a two-way QKD system is degraded by noise in the form of photons generated from the initially relatively strong quantum signal by three different mechanisms: 1) forward Raman scattering, in which frequency-shifted photons are generated and co-propagate with the quantum signal photons; 2) Raman backscattering, in which frequency-shifted photons are generated and propagate in the opposite direction to the quantum signal photons; and 3) Rayleigh scattering, in which photons from the quantum signal are elastically scattered back in the opposite direction of the quantum signal photons.

It is possible to minimize noise from Raman forward scattering and backscattering by wavelength-division multiplexing (WDM), time-division multiplexing (TDM) or wavelength filtering. However, Rayleigh backscattering presents a more difficult problem because Rayleigh backscattered photons have the same frequency as the quantum signal photons. Thus, WDM solutions that attempt to separate quantum signals from the noise they generate are not applicable. In addition, since the Rayleigh backscattered photons are elastically scattered throughout the transmission fiber, they arrive at the detectors at a constant (continuous wave) rate, making TDM solutions ineffective.

It is important to note that the two-way QKD system described in the Ribordy paper uses a “storage line” in the form of a 13.2 km long fiber loop to suppress the detection of Rayleigh backscattered light. Such a storage line adversely affects the transmission rate of a two-way QKD system.

### SUMMARY OF THE INVENTION

One aspect of the invention is a QKD station adapted for optical coupling via an optical fiber to a second QKD station of a QKD system. The QKD station includes first and second laser sources each adapted to emit outgoing optical pulses into the optical fiber. The outgoing optical pulses have first and second wavelengths corresponding to that of the first and second laser sources. The QKD station also includes first and second single-photon detectors (SPDs) respectively adapted to detect optical pulses of the first and second wavelengths as incoming weak optical pulses returned to the first QKD station from another QKD station. In an example embodiment, the SPDs are arranged as pairs, where each pair detects a given wavelength. Also included in the QKD station is a controller operably coupled to the first and second laser sources and to the first and second SPDs. The controller is adapted to sequentially activate and deactivate the first and second laser sources to generate corresponding first and second sets of the outgoing optical pulses. The controller is additionally adapted to sequentially activate and deactivate the first and second SPDs to reduce an amount of backscattered light formed in the optical fiber by the outgoing pulses from being detected by the first and second SPDs.

Another aspect of the invention is a method of detecting optical pulses in a QKD system having first and second QKD stations. The method includes transmitting a first set of optical pulses having a first wavelength from a first QKD station to a second QKD station, terminating the transmission of the first set of optical pulses, and transmitting a second set of optical pulses having a second wavelength from the first QKD station to the second QKD station at a time that prevents backscattered radiation from the first set of optical pulses from being detected in the first QKD station.

Another aspect of the invention is a method of reducing Rayleigh backscattering in a QKD system having first and second QKD stations optically coupled via an optical fiber link. The first QKD station has first and second selectively activatable single-photon detectors (SPDs) optically coupled to the optical fiber link and adapted to detect single photons having respective first and second wavelengths. In an example embodiment, the SPDs are arranged in pairs, where each pair is adapted to detect a single wavelength. The method includes multiplexing in the first QKD station first and second sets of pairs of optical pulses into the optical fiber link. The first and second sets have the first and second wavelengths, respectively. The method also includes selectively activating the first and second SPDs to reduce or prevent backscattered light formed in the optical fiber link from being detected by the SPDs when detecting single photons.

### BRIEF DESCRIPTION OF THE DRAWINGS

FIG. 1 is a schematic diagram of an example two-way QKD system;

FIG. 2 is a schematic diagram of an example embodiment of the QKD station Bob according to the present invention for use in the two-way QKD system of FIG. 1, wherein Bob is capable of transmitting quantum signals having three different wavelengths;

FIG. 3A is a schematic diagram that illustrates the timing of generating optical pulses of a second wavelength when optical pulses of a first wavelength are arriving at their corresponding single-photon detectors (SPDs);

FIG. 3B is a schematic diagram that illustrates the timing of generating optical pulses of a third wavelength when optical pulses of the second wavelength are arriving at their corresponding SPDs;

FIG. 4 is a timing diagram illustrating the time segments over which the laser sources send their respective optical pulses of different wavelengths;

FIG. 5A is a schematic diagram that illustrates the timing of generating optical pulses of a second wavelength when optical pulses of a first wavelength are arriving at their corresponding single-photon detectors (SPDs);

FIG. 5B is a schematic diagram that illustrates the timing of generating optical pulses of a third wavelength when optical pulses of the second wavelength are arriving at their corresponding SPDs;

FIG. 6 is a schematic diagram of a portion of Bob illustrating the use of a multiplexer instead of three separate optical couplers; and

FIG. 7 is a schematic diagram of a portion of Bob illustrating the use of a single polarization-maintaining variable optical attenuator (PM VOA) arranged downstream of the multiplexer, instead of using three separate PM VOAs as illustrated in FIG. 2.

The various elements depicted in the drawings are merely representational and are not necessarily drawn to scale. Certain sections thereof may be exaggerated, while others may be minimized. The drawings are intended to illustrate various embodiments of the invention that can be understood and appropriately carried out by those of ordinary skill in the art.

### DETAILED DESCRIPTION OF THE INVENTION

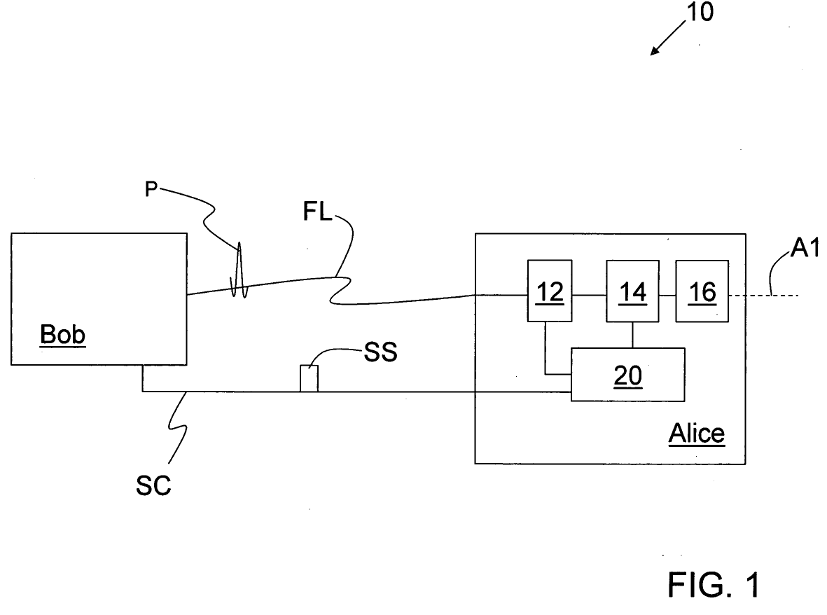

The present invention relates to a two-way QKD system, and in particular to a method of suppressing noise in such a QKD system that arises from Rayleigh backscattering. FIG. 1 is a schematic diagram of an example two-way QKD system 10. QKD system 10 includes a first QKD station “Bob” and a second QKD station “Alice” connected to each other via an optical fiber link FL. Optical signals (pulses) P are sent over optical fiber link FL between Alice and Bob. These optical pulses are also referred to herein as “quantum pulses” because they are sent over what is referred to in the art as the “quantum channel.”

The optical (quantum) pulses returned from Alice to Bob, as described below, generally have an average number of photons of 1 or fewer, and preferably about 0.1. The details of Bob according to the present invention are below.

With continuing reference to FIG. 1, in an example embodiment, Alice includes a variable optical attenuator (VOA) 12, a phase modulator 14 and a Faraday mirror 16 arranged in order along an optical axis A1. Alice also includes a controller 20 coupled to VOA and to phase modulator 14 to control the operation of these elements.

In an example embodiment, Alice and Bob are also coupled via a synchronization channel SC that allows for synchronization signals SS to be sent from one station to the other to control the timing and operation of the various elements making up the QKD system. In an example embodiment, the synchronization channel SC is multiplexed with the quantum channel over optical fiber link FL.

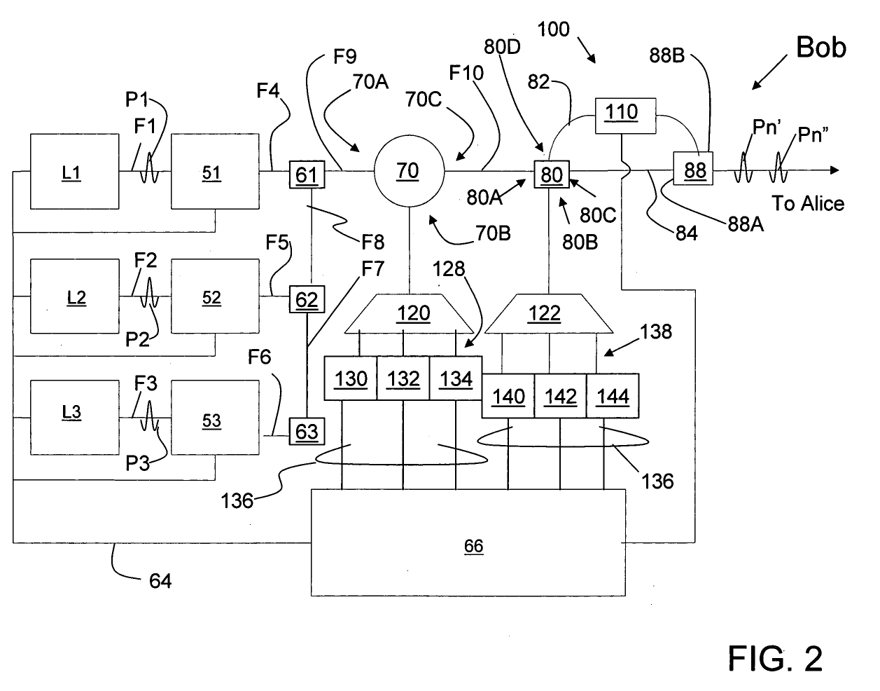

Bob FIG. 2 is a schematic diagram of an example embodiment of Bob according to the present invention suitable for use in the two-way QKD system 10 of FIG. 1. Bob includes a plurality of laser sources L—for example three laser sources L1, L2 and L3, as shown. Lasers L1, L2 and L3 emit respective optical pulses P1, P2 and P3 having respective wavelengths λ1, λ2, and λ3.

Lasers L1, L2 and L3 are optically coupled to respective polarization-maintaining (PM) VOAs 51, 52 and 53 e.g., via respective fiber sections F1, F2 and F3. PM VOAs 51, 52 and 53 are in turn optically coupled to respective couplers 61, 62 and 63 e.g., via fiber sections F4, F5 and F6. Couplers 61, 62 and 63 are arranged in series, with coupler 63 optically coupled to coupler 62, e.g., via fiber section F7, and coupler 62 optically coupled to coupler 61, e.g., via fiber section F8. Lasers L1, L2 and L3, and PM VOAs 51, 52 and 53 are operably (e.g., electrically) coupled via a (branching) line 64 (e.g., a wire) to a controller 66 that controls the activation and timing of these elements, as discussed in detail below.

Bob further includes a circulator 70 with ports 70A, 70B and 70C. Coupler 61 is optically coupled to first circulator port 70A, e.g., via a fiber section F9. Also, a 3 dB coupler 80 with four ports 80A-80D is optically coupled to third circulator port 70C, e.g., via a fiber section F10 connected to the coupler at port 80A.

Coupler 80 is coupled to two fiber sections 82 and 84 at respective ports 80D and 80C. The opposite ends of fibers 82 and 84 are coupled to respective faces 88A and 88B of a polarizing beam splitter 88, thereby forming an interferometer loop 100 with arms 82 and 84. A phase modulator 110 is arranged in one of the arms (e.g., arm 82). Phase modulator 110 is operatively coupled to controller 66.

Bob also includes a first WDM demultiplexer 120 optically coupled to port 70B of circulator 70 and a second WDM demultiplexer 122 optically coupled to coupler 80 at port 80B. First demultiplexer 120 is optically coupled to a detector unit 128 having three single-photon detectors (SPDs) 130, 132 and 134 (e.g., via respective optical fibers 136). Second demultiplexer 122 is optically coupled to a detector unit 138 having three single-photon detectors 140, 142 and 144 (e.g., via respective optical fibers 146). Each of the single-photon detectors is in turn coupled to controller 66. SPDs 130 and 140 corresponding to laser source L1 and λ1, SPDs 132 and 142 correspond to laser source L2 and λ2, and SPDs 134 and 144 correspond to laser source L3 and λ3. The SPD pairs constitute a set of SPDs that correspond to each wavelength used.

Note that the above description is an example embodiment of an arrangement for Bob. Other arrangements are possible, and the above-described arrangement is for the sake of illustration. For example, rather than SPD pairs, Bob can operate using a single SPD for each wavelength of light, e.g., by means of a delay line and gating pulses provided by controller 66. The discussion below uses SPD pairs for ease of illustration and understanding.

Method of Operation

In the present invention, both time and wavelength demultiplexing can be used to suppress the adverse effects associated with Rayleigh backscattering. Generally, backscattering occurs over the length of the optical fiber and backscattered light can reach the SPDs from portions of the optical fiber as far as at or near Alice. In certain instances, however, most of the backscattering in QKD system 10 (FIG. 1) occurs in the portions of optical fiber link FL near Bob where the original outgoing optical pulses P are still strong. These pulses also have a higher probability of reaching a detector since they are less likely to be lost in fiber link FL on the way back to Bob. Generally, there is some effective distance along the length of the fiber link FL as measured from Bob beyond which the effects of backscattering on the detection process are minimal. In an example embodiment, this effective distance is determined empirically by varying the timing of the generation and detection of optical pulses of different wavelength to find an optimal timing arrangement.

With continuing reference to FIG. 2, to minimize the adverse effects of Rayleigh backscattering, laser sources L1, L2 and L3 and the corresponding SPDs are operated in sequence. For example, laser source L1 generates a number (set) N1 of pulses P1 that pass through PM VOA 51, through coupler 61, through circulator 70, and to loop 100. At loop 100, each pulse P1 is split into two coherent optical pulses, shown generically in FIG. 2 as Pn′ and Pn″. The pairs of pulses travel to Alice where at least one pulse in each pair is modulated. The pulse pairs are then returned to Bob where the returned pulses that travel through arm 82 are phase modulated with a randomly selected phase (e.g., via a random number generator in controller 66).

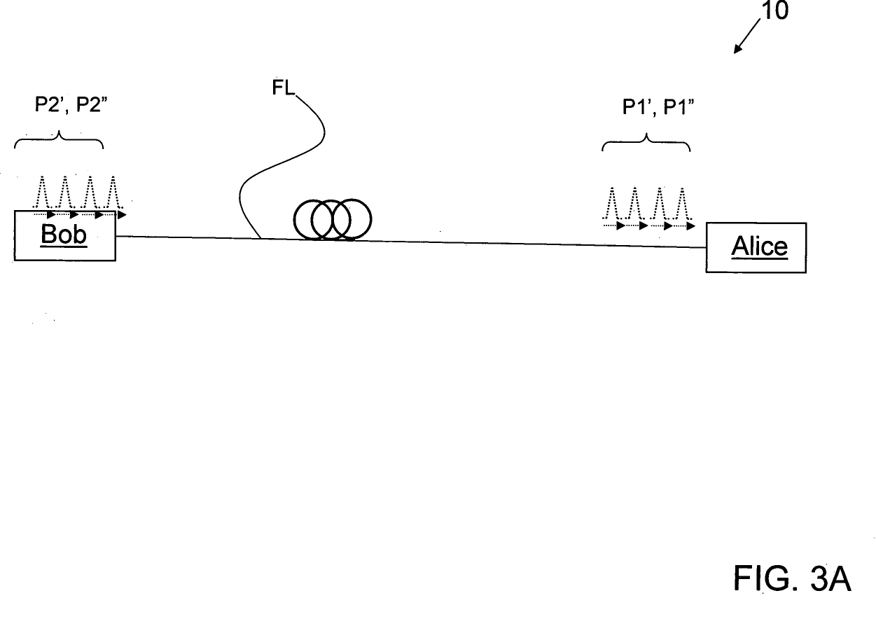

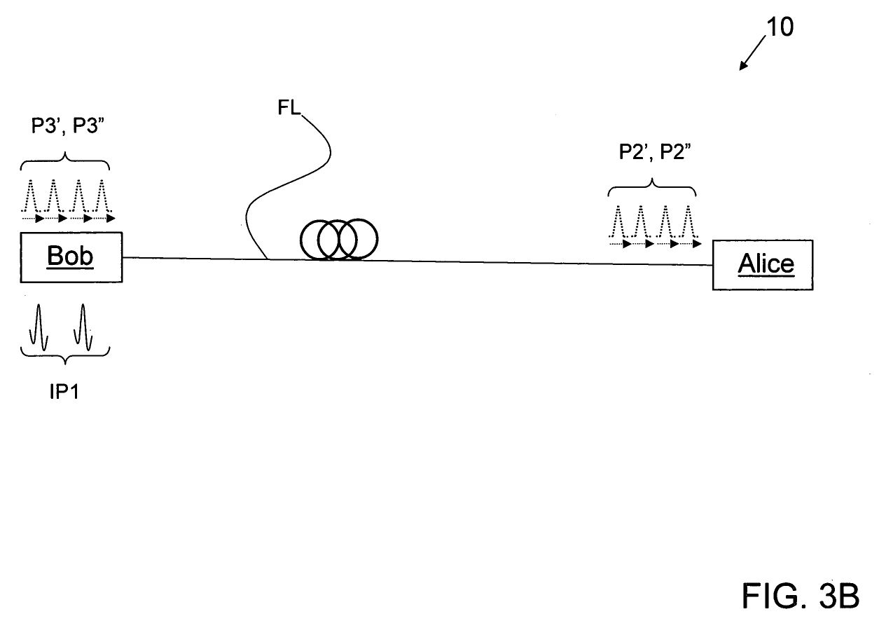

Each returned pair of pulses is recombined (interfered) at coupler 80 to form a single interfered pulse IP1 (see FIG. 3A). The interfered pulse passes either to demultiplexer 122 via coupler 80 or to demultiplexer 120 through circulator 70, depending on the overall phase of the interfered pulse. Demultiplexer 120 or 122 then directs the interfered pulse (which has a wavelength λ1) to SPD 130 or 140 in respective detector units 128 and 138. The operation of SPD 130 and 140 is gated via controller 66 to correspond to the arrival time of the interfered pulse

Backscattering Along The Entire Fiber Length

In the most general case, backscattering in QKD system 10 (FIG. 1) occurs along the entire length of optical fiber link FL.

With reference also to FIG. 3A, at or about the time when the first set of optical pulses arrives at Alice, controller 66 deactivates laser source L1 and activates laser source L2. Laser source L2 then emits a number (set) N2 of optical pulses P2. Optical pulses P2 pass through PM VOA 52, through coupler 62 and pass to coupler 61. Likewise, with reference to FIG. 3B, at or about the time when optical pulses P2 start arriving at Alice (and at or about the time when interfered pulses IP1 are formed in Bob), controller 66 deactivates laser source L2 and activates laser source L3, which emits a number (set) N3 of optical pulse P3. Then, at or about the time when optical pulses P3 start arriving at Alice, controller 66 deactivates laser source L3 and activates laser source L1 and the process repeated.

In the meantime, controller 66 sequentially activates SPD pairs 130 and 140, 132 and 142, and 134 and 144 to detect respective interfered optical pulses IP1, IP2 and IP3 having respective wavelengths λ1, λ2 and λ3 as the different optical pulse sets sequentially arrive at Bob.

Switching the wavelength of optical pulses P from one wavelength to another wavelength just as the optical pulses of one wavelength arrive at Alice prevents Rayleigh backscattered light of the one wavelength from reaching the SPDs designated to detect photons of that wavelength just as the quantum pulses of that wavelength are being detected.

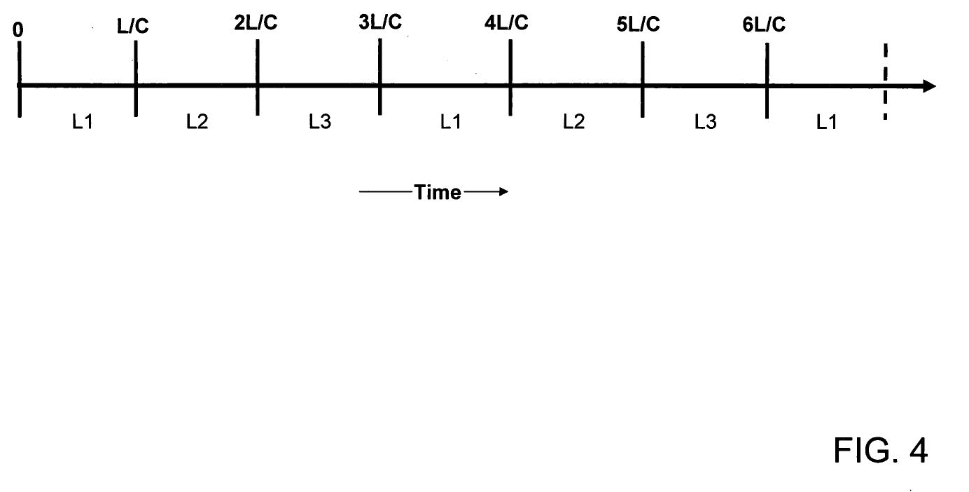

With reference to FIG. 4, in an example embodiment, each laser source L1, L2 and L3 emits sets of optical pulses for a time duration of L/C, and is off for the consecutive period of 2(LF)/c, where LF is the length of optical fiber link FL between Bob and Alice and c is the speed of light in the fiber. In a more general example embodiment where there are n laser sources L1, L2, . . . Ln, each laser emits for a time duration of LF/C and is off for the consecutive period of (n−1)(LF)/c. In this example embodiment, Rayleigh scattering is completely time-demultiplexed.

Strongest Backscattering Near Bob

As mentioned above, in certain instances, most of the backscattering in QKD system 10 (FIG. 1) occurs in the portions of optical fiber link FL near Bob where the original outgoing optical pulses P are still strong. These pulses also have a higher probability of reaching a detector since they are less likely to be lost in fiber link FL on the way back to Bob.

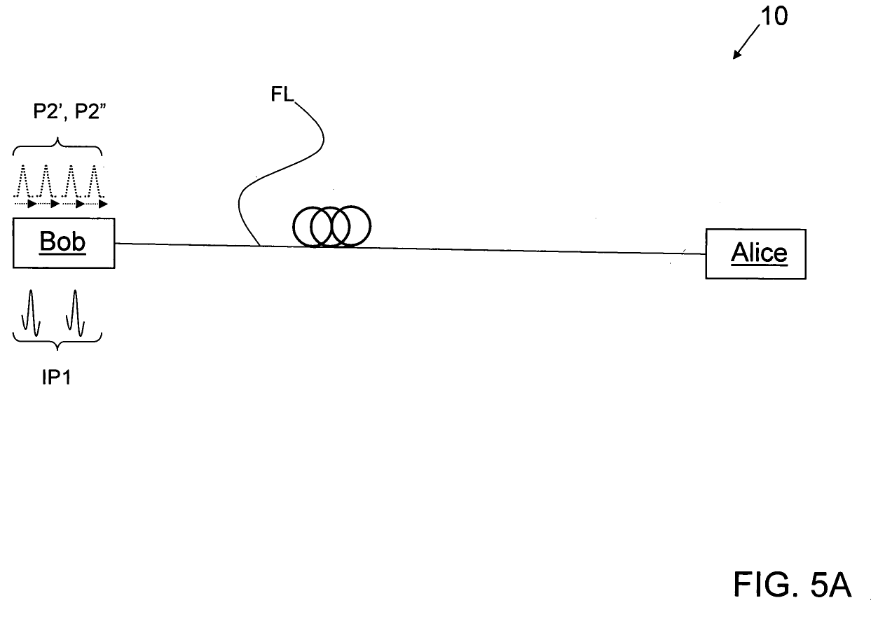

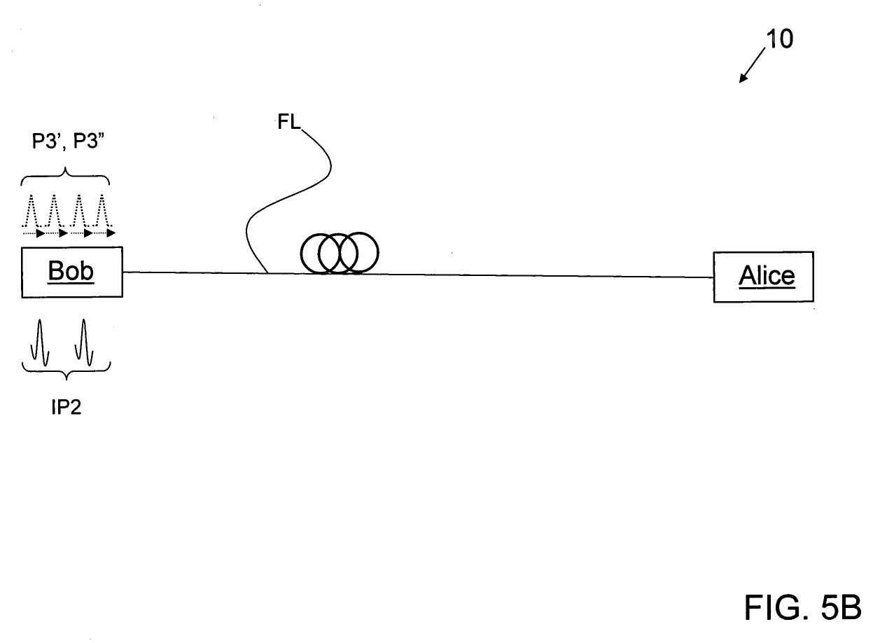

Accordingly, with reference also to FIG. 5A, in one example embodiment, at or about the time when interfered pulses (photons) IP1 start arriving at SPDs 130 and 140, controller 66 deactivates laser source L1 and activates laser source L2. Laser source L2 then emits a number (set) N2 of optical pulses P2. Optical pulses P2 pass through PM VOA 52, through coupler 62 and pass to coupler 61. At this point, the operation of the QKD system is essentially the same as described above in connection with optical pulses P1, except that now SPDs 132 and 142 are gated to detect arriving interfered pulses having wavelength λ2.

Likewise, with reference to FIG. 5B, at or about the time when interfered pulses IP2 having wavelength λ2 start arriving at SPDs 132 and 142, controller 66 deactivates laser source L2 and activates laser source L3. Laser source L2 then emits a number (set) N3 of optical pulses P3. Optical pulses P3 pass through PM VOA 53 and through couplers 63, 62 and 61. At this point, the operation of the QKD system is essentially the same as described above in connection with optical pulses P1, except that now SPDs 134 and 144 are gated to detect arriving interfered pulses having wavelength λ3.

At or about the time when interfered pulses IP3 (not shown) start arriving at SPDs 134 and 144, controller 66 deactivates laser source L3 and activates. laser source L1, and the above-described process repeated until a desired number of qubits are exchanged. Generally, each laser source L1, L2 . . . Ln emits for a time duration of 2(LF)/c and is off for the consecutive period of 2(n−1)(LF)/c.

Switching the wavelength of optical pulses P from a first wavelength to a second wavelength just as the optical pulses of the first wavelength are being detected decreases the amount of Rayleigh backscattered light of the first wavelength from reaching the SPDs designated to detect photons of the first wavelength just as the quantum pulses of that wavelength are being detected. The amount of the decrease is non-uniform and increases exponentially with time during each cycle.

The amount of Rayleigh backscattered photons, R, of a certain wavelength reaching the SPDs as this wavelength is being detected can be expressed as R=Ae^{-Bt}, where time t varies between 0 and 2(LF)/C during each cycle, and where A and B are the system parameters that depend on fiber length (FL), its loss and the system architecture.

Key Generation

In the present invention, the conventional QKD protocols are used to extract a key from the exchanged optical pulses. When photons (pulses) are detected (i.e., as detector clicks) in the SPDs, it is important to know which SPD pair generated the click. When a detection event occurs in an SPD set that is not presently activated (gated), this event (click) should be discarded, since it corresponds to the wrong wavelength—and thus can be considered to originate from dark current or another type of detector error.

Other Example Embodiment of Bob

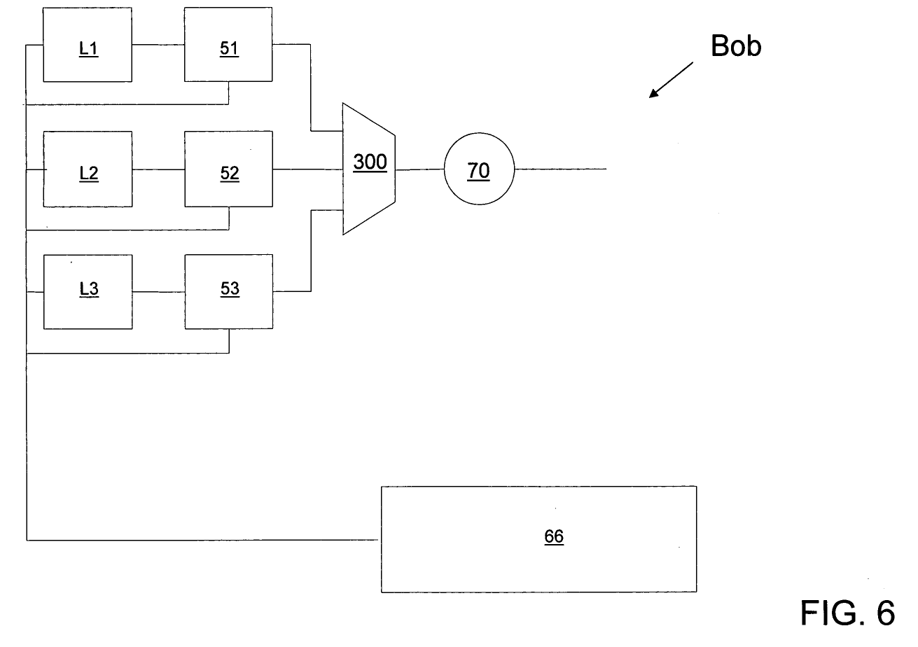

FIG. 6 is a schematic diagram of a section of Bob similar to that of FIG. 2, illustrating an example embodiment wherein a multiplexer 300 (e.g., a conventional optical multiplexer, a micro-electro-mechanical (MEMS) device, etc.) is used to combine the optical pulses P from the different laser sources L and send them to circulator 70. This example embodiment eliminates the need for individual couplers 61, 62 and 63.

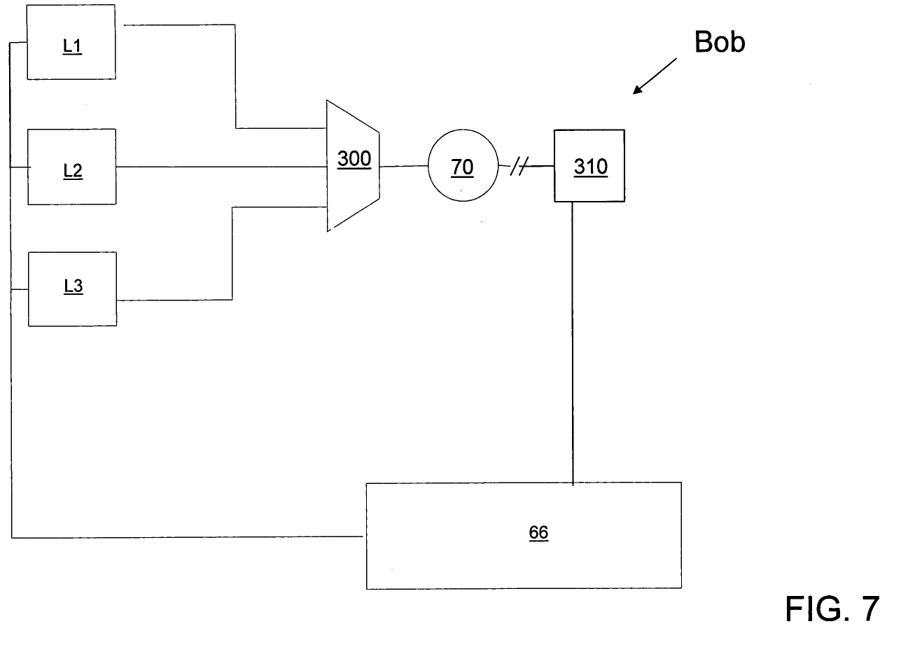

FIG. 7 is a schematic diagram of a section of Bob similar to that of FIG. 5, illustrating an example embodiment wherein a single PM VOA 310 is arranged downstream of multiplexer 300. This example embodiment eliminates the need for three different PM VOAs.

There are many other variations and example embodiments that could be set forth to describe the present invention. For example, the SPDs need not be arranged in pairs as described above, but may be arranged as single SPDs for each wavelength. Accordingly, the many features and advantages of the present invention are apparent from the detailed specification, and, thus, it is intended by the appended claims to cover all such features and advantages of the described apparatus that follow the true spirit and scope of the invention. In the foregoing Detailed Description, various features are grouped together in various example embodiments for ease of understanding. Furthermore, since numerous modifications and changes will readily occur to those of skill in the art, it is not desired to limit the invention to the exact construction, operation and example embodiments described herein.

What is claimed is:

1. A first QKD station adapted for optical coupling via an optical fiber to a second QKD station of a QKD system, the first QKD station comprising:
first and second laser sources each adapted to emit outgoing optical pulses into the optical fiber, the outgoing optical pulses having first and second wavelengths corresponding to the first and second laser sources;
first and second single-photon detectors (SPDs) respectively adapted to detect optical pulses of the first and second wavelengths as incoming weak optical pulses returned to the first QKD station from the second QKD station;
a controller operably coupled to the first and second laser sources and to the first and second SPDs; and
wherein the controller is adapted to sequentially activate and deactivate the first and second laser sources to generate corresponding first and second sets of said outgoing optical pulses, and is adapted sequentially activate and deactivate the first and second SPDs to reduce an amount of backscattered light formed in the optical fiber by the outgoing pulses from being detected by the first and second SPDs.

2. The station of claim 1, wherein the first and second SPDs each include an SPD pair.

3. A first QKD station adapted to be optically coupled to a second QKD station in a QKD system via an optical fiber, the first QKD station comprising:
two or more laser sources multiplexed to emit outgoing optical pulses of respective two or more wavelengths into the optical fiber;
two or more single-photon detectors (SPDs) respectively adapted to detect optical pulses of the two or more wavelengths after said optical pulses are sent to the second QKD station and returned as weak optical pulses to the first QKD station; and
a controller operably coupled to the two or more laser sources and to the two or more SPDs, the controller adapted to sequentially activate the two or more laser sources and to sequentially activate the two or more SPDs to reduce or prevent the detection of backscattered radiation from the optical fiber by the two or more SPDs.

4. The QKD station of claim 3, wherein the each of the two or more SPDs includes an SPD pair.

5. The system of claim 3, including a multiplexer adapted to multiplex the outgoing optical pulses of the two or more wavelengths into the optical fiber.

6. A method of detecting optical pulses in a QKD system having first and second QKD stations coupled by an optical fiber, comprising:
transmitting a first set of optical pulses having a first wavelength from a first QKD station to a second QKD station;
terminating the transmission of the first set of optical pulses to reduce or prevent an amount of Rayleigh backscattered radiation from the optical fiber from being detected in the first QKD station; and
transmitting a second set of optical pulses having a second wavelength from the first QKD station to the second QKD station.

7. The method of claim 6, including terminating the transmitting of the first set of optical pulses and initiating the transmitting of the second set of optical pulses at or near a time when the first set of optical pulses reaches the second QKD station.

8. The method of claim 6, including terminating the transmitting of the first set of optical pulses and initiating the transmitting of the second set of optical pulses at or near a time when the first set of optical pulses return to the first QKD station from the second QKD station.

9. The method of claim 6, including detecting the first set of optical pulses as weak optical pulses with a first single-photon detector (SPD) pair and detecting the second set of optical pulses with a second SPD pair.

10. The method of claim 6, further including:
terminating transmission of the second set of optical pulses at or near the time when weak optical pulses from the second set of optical pulses returned to the first QKD station from the second QKD station are to be detected; and
while detecting the second set of weak optical pulses, transmitting another first set of optical pulses having the first wavelength from the first QKD station to the second QKD station.

11. The method of claim 6, further including:
terminating transmission of the second set of optical pulses at or near the time when weak optical pulses from the second set of optical pulses returned to the first QKD station from the second QKD station are to be detected; and
while detecting the weak optical pulses from the second set of optical pulses, transmitting to the second QKD station a third set of optical pulses having a third wavelength from the first QKD station to the second QKD station.

12. A method of reducing Rayleigh backscattering in a QKD system having first and second QKD stations optically coupled via an optical fiber link, the method comprising:
in the first QKD station having first and second selectively activatable single-photon detectors (SPDs) optically coupled to the optical fiber link and adapted to detect single photons having respective first and second wavelengths: multiplexing first and second sets of pairs of optical pulses into the optical fiber link, the first and second sets having the respective first and second wavelengths; and
selectively activating the first and second SPDs to reduce or prevent backscattered light formed in the optical fiber link from being detected by the SPDs when detecting single photons.

13. The method of claim 12, including arranging the each of the first and second SPDs as pairs of SPDs.

14. The method of claim 12, including generating the first and second pairs of optical pulses by selectively activating first and second laser sources optically coupled to the optical fiber link.

15. The method of claim 12, including optically coupling the first and second SPDs to the optical fiber link using optical fiber sections.

16. The method of claim 12, including demultiplexing the first and second sets of pairs of optical pulses in the first QKD station when they are returned from the second QKD station.

17. The method of claim 12, wherein selectively activating the SPDs includes providing the first and second SPDs with respective first and second gating pulses respectively timed to the expected arrival of the first and second sets of pairs of optical pulses.

18. The method of claim 12, further including combining SPD measurements from each of the first and second SPDs to form a raw key.
